(19) United States
(12) Patent Application Publication
(10) Pub. No.: US 2003/0229463 A1
(43) Pub. Date: Dec. 11, 2003

(54) Systematic method and system for quality control

(76) Inventor: Chun-Chen Chen, Shindian City (TW)

Correspondence Address: RABIN & CHAMPAGNE, PC, 1101 14TH STREET, NW, SUITE 500, WASHINGTON, DC, 20005, US

(21) Appl. No.: 10/288,294

(22) Filed: Nov. 6, 2002

(30) Foreign Application Priority Data
Jun. 5, 2002 (TW) 091112086

(51) Int. Cl. G06F 19/00

(52) U.S. Cl. 702/84

(57) ABSTRACT

A systematic method for control the quality of the present invention is used at the packaging station of an assembling production line of an information product. The packaging station has a digital weighing device and a computing device. The systematic method for quality control of the present invention includes the following steps. An information product package is weighed on a digital weighing device and getting a weight value. The configuration data of the information products is input into a computing device to calculate a reference weight data. The weight value of the product package is input into the computing device and is compared the weight value of the information product with the reference weight data thereof on the computing device. The compared result is displayed on the computing device.

This application incorporates by reference of Taiwan application Serial No. 091112086, filed Jun. 5, 2002.

### BACKGROUND OF THE INVENTION

1. Field of the Invention

This invention relates to a systematic method and system for quality control, and more particularly, the invention relates to a systematic method and system for quality control of the production of information products.

2. Description of Related Art

With respect to the assembling production line for information products, the quality control of the information products is one of the main issues and is demanded to be improved. Especially in the production modes of built-to-order (BTO) and configure-to-order (CTO), the configurations of information products, such as notebooks, are varied from one to one. In such a circumstance, the quality control for the information products is hard to handle. For example, an operator may mistakenly put unnecessary parts into the product packaging boxes. This issue occurs from time to time, because the information products with different configurations are assembled on the same production lines either in BTO or CTO production modes. Because the configurations of the information products are varied from one to one, it is more difficult to handle and control the exactly necessary associated parts for each information product, for example, the wrong parts may be packaged or the necessary parts may be missed in the package boxes due to the operators' carelessness. It is a manpower- and time-consuming task to check the accurate parts for each configuration of information products in BTO or CTO production modes. Especially, when the package box is sealed, it consumes more manpower to correct it. Thus, it is demanded to have a systematic method and system to control the production lines of information products, especially, to control the quality of the different configurations of information products on BTO or CTO production line. The method of present invention can prevent from checking the product packages one by one by opening them in order to enhance the efficiency of the production line of information products.

### SUMMARY OF THE INVENTION

It is an object of the present invention to provide a systematic method and system for controlling the quality of the information products.

It is another object of the present invention to provide a systematic method and system for controlling the quality of the information products with different configurations on the same production line

In accordance with an aspect of the present invention, a systematic method for controlling the quality of an information product on a production line by checking the weight of package boxes of the information products to determine the correction of the parts of the information products. The systematic method of the present invention comprises the steps of weighing an information product package on a digital weighing device and getting a weight value, inputting the configuration data of the information products into a computing device to calculate a reference weight data, inputting the weight value of the product package into the computing device, comparing the weight value of the information product with the reference weight data thereof on the computing device, and displaying the compared result on the computing device.

Because the configurations of information products are different from one to one, the total weights thereof are different after packaging. Thus, the method of present invention is based on the weight of the information products package to check the correction of the necessary assembling items and the associated parts for the information products.

In accordance with another aspect of the present invention, the system of the present invention for quality control in a production line includes a digital weighing device, and a computing device, in which the computing device is coupled to the digital weighing device.

In accordance with another aspect of the present invention, the systematic method of the present invention for quality control is used at the packaging station of an assembling production line. The packaging station is equipped with a digital weighing device and a computing device. The system of the present invention for quality control on a production line of information products comprises a packaging station in the production line, a digital weighing device, and a computing device, wherein the computing device is coupled to the digital weighing device. In one preferred embodiment, the computing device and the digital weighing device are coupled either by serial communication network or Ethernet network.

### BRIEF DESCRIPTION OF DRAWINGS

The invention can be more fully understood by reading the following detailed description of the preferred embodiments, with reference made to the accompanying drawings, wherein:

FIG. 1 is a flow diagram, schematically illustrating the process flow of the checking method according to the preferred embodiment of the present invention.

### DETAILED DESCRIPTION OF PREFERRED EMBODIMENTS

In the following, a preferred embodiment of the present invention is provided as an example. In this preferred embodiment, the system of the present invention for quality control on a production line of information products at least includes a packaging station, a computing device, and a digital weighing device, in which the computing device is coupled with the digital weighing device. The computing device and the digital weighing device are equipped at the packaging station. The digital weighing device preferably is coupled with the computing device via an RS-232 serial communication interface. In a preferred embodiment of the present invention, the digital weighing device can also be coupled with the computing device via a network manner, such as a local area network (LAN) and the likes. The computing device preferably is a personal computer or other types of similar devices, such as a laptop, industry computer, and the likes. In this embodiment, the computing device is a laptop. The system of the present invention for the quality control uses a data management system (DBMS) to store the data used in the present systematic method and system, for example, the configuration data of information products manufactured in the assembling production line, and the reference weight data corresponding to each product configuration, the acceptable tolerance errors of the weight value of the product package boxes and the likes. In a preferred embodiment of the present invention, the database is a relational database management system (RDBMS) type, such as MS SQL SERVER, ORACLE and the likes.

During the production stage, a work sheet is provided to list the production information of information products. The production information includes the part number for a specific configuration of an information product, the amount of the products, the corresponding production serial numbers and the likes. In a preferred embodiment of the present invention, the production information is shown as a barcode or other recording format. On the production line of the information products, a part number represents a specific configuration of an information product. Before the products are assembled on the production line, the part number on the work sheet is input to the database to obtain the detailed data of configuration of the information product, i.e. the list of the related parts of the product. In addition to the information related to a specific part number, all of the reference weight information corresponding to each part number is stored into this database. The reference weight information includes the total weight of the corresponding products after assembled and packaged which is caculated from each part in the corresponding configuration for the products, and the data related to the range of acceptable tolerance error.

When the product is assembled and packaged, the package of the product is transferred to the packaging station, the package of the product is put on the digital weighing device to get the weight value. The part number of the product is input into the laptop to get the reference weight value for the specific part number. The weight value got from the digital weighing device is input into the laptop to compare with the reference weight value. Then, the laptop executes an operational program for comparing the weight information. The laptop will display the result information on the screen, so as to show a notice regarding whether or not the product package has passed by meeting the weight requirement. The manner of showing notices to inform the result information can also alternatively shown by an audio signal, a warning lamp, and the likes, in addition to the screen display.

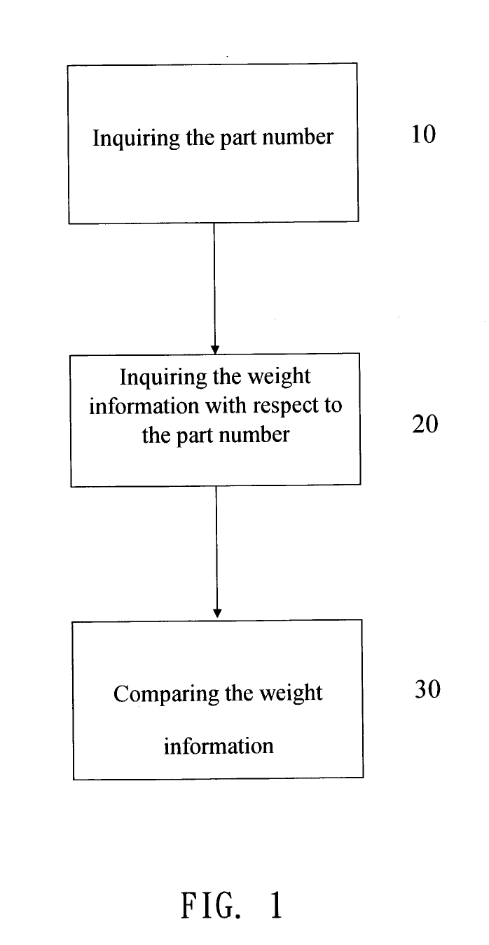

FIG. 1 is a flow diagram, schematically illustrating the process flow of the systematic method according to the preferred embodiment of the present invention. On the production line, the packaged product boxes are transported to the package station. At the package station, the production serial number, as in a format of barcode, is read and input into the laptop to inquire the information of this product, such as the specific part number, as shown as step 10 of FIG. 1. According to the specific part number for the production serial number, the reference weight value is inquired from the database, as shown as the step 20 of FIG. 1. The weight value from the weighing device is input into laptop via the RS232 interface. The laptop will compare the reference weight value of the product inquired from the database and the weight value of the product read from the weighing device to determine whether or not the product is in the acceptable weight range, as shown in FIG. 1 at the step 30. If the data of the digital weighing device is within the acceptable weight range, then the screen will display an indication of “pass”; otherwise an indication of “no pass”.

As described in the foregoing embodiment, the present invention can check if the information product package has a missing or incorrect item. This systematic method and system can avoid the problem of having to open the sealed package to check if all the necessary parts and/or accessories for an information product are packaged. In addition, the present invention can be applied as a procedure step in the production process flow of an information product so as to enhance the efficiency of operation in quality control.

The present invention has disclosed a system for the quality control of a production line for an information product, used to check each product package by its weight, to enhance the efficiency of operation in quality control.

The present invention utilizes the manner of checking the weight of the information product package to determine if the product package has an incorrect or missing item of the associated parts for the product. This can avoid the issue of having to open the packages one by one to check for correct parts for a product package.

The present invention utilizes that different weight of the final information products manufactured on a same production line due to the different configurations for the quality control, so that the product package with the missing or incorrect part can be efficiently examined. Then the operation efficiency with quality control can be effectively improved.

The present invention not only can be applied to the information industry in the production modes of BTO and CTO, but also can be applied to a production mode having a small number of products but with a large number of assembly parts or with rather complicated assembly parts.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A systematic method for quality control on a production line of an information product, the method comprising the steps of:
weighing an information product package on a digital weighing device and getting a weight value,
input the configuration data of the information products into a computing device to calculate a reference weight data,
input the weight value of the product package into the computing device,
comparing the weight value of the information product with the reference weight data thereof on the computing device, and
displaying the compared result on the computing device.

2. The systematic method for quality control as recited in claim 1, wherein the configuration data is in a format of a product serial number.

3. The systematic method for quality control as recited in claim 2, wherein the product serial number can be read by optical scanning device to input into the computing device.

4. The systematic method for quality control as recited in claim 1, wherein the reference weight data of the product comprises a total weight of the information product and an acceptable deviation.

5. The systematic method for quality control as recited in claim 1, wherein the reference weight data of the products is stored in a database management system.

6. A systematic system for quality control on a production line of information products, comprising:
a packaging station in the production line;
a digital weighing device; and
a computing device, wherein the computing device is coupled to the digital weighing device.

7. The systematic system for quality control as recited in claim 6, wherein the computing device further comprises a warning lamp.

8. The systematic system for quality control as recited in claim 6, wherein the computing device further comprises an audio device coupled therewith.

9. The systematic system for a quality control as recited in claim 6, wherein the computing device is coupled to the digital weighing device via a network.

10. The systematic system for a quality control as recited in claim 6, wherein the computing device is coupled to the digital weighing device via a wireless network.
